(19) United States
(12) Patent Application Publication
(10) Pub. No.: US 2012/0209892 A1
(43) Pub. Date: Aug. 16, 2012

(54) SYSTEMS AND METHODS RELATED TO AGGREGATION OF DISPARATE DATABASE CONTENT

(76) Inventors: Don MacAskill, Los Altos, CA (US); Chris MacAskill, Mountain View, CA (US); Brian Strong, San Jose, CA (US)

(21) Appl. No.: 13/027,099

(22) Filed: Feb. 14, 2011

(51) Int. Cl. G06F 17/30

(52) U.S. Cl. 707/812; 707/E17.005

(57) ABSTRACT

Systems, devices, and methods are disclosed for sharing disparate galleries of files among a plurality of users without duplicating the files in a file storage device. The systems, devices, and methods of this disclosure are effective with photograph files, music files, video files, word processing files, and other types of files that are organized into galleries or sub-galleries.

### BACKGROUND

This disclosure relates to aggregation of disparate gallery content into a single gallery, including the use of rule based population of gallery items.

### SUMMARY

Systems, devices, and methods are disclosed for sharing disparate galleries of files among a plurality of users without duplicating the files in a file storage device. The systems, devices, and methods of this disclosure are effective with photograph files, music files, video files, word processing files, and other types of files that are organized into galleries or sub-galleries.

According to a feature of the present disclosure, a system is disclosed comprising a server, and a database storing the location of a plurality of files, each file having a record in the database and being associated with a gallery, a back-end, and a front-end. The owner of each gallery can collect files from another gallery if and only if: the files in the other gallery are public and the files in the other gallery are marked collectable. The user can either manually collect the files or have the files automatically collected based on at least one rule defined by the user.

According to a feature of the present disclosure, a method is disclosed comprising, on a computer receiving a file from a file owner into a first gallery owned by the file owner, wherein when the file is received, a record of the file is made in a first gallery table associated with the first gallery, causing the storage of the file in a file storage, providing a set of settings options to the file owner comprising at least an option to make the file public and allow the file to be collected, and receiving a request from a user to collect the file into a gallery owned by the user, wherein a record of the file is made in a second gallery table, thereby causing the file to be collected into the second gallery. The file is collected to the second gallery only if the owner has designated the file as public and designed that the file is collectable. Only a single copy of the file is contained in the file storage.

According to a feature of the present disclosure, a machine-readable medium having instructions thereon comprising receiving a file from a file owner into a first gallery owned by the file owner, wherein when the file is received, a record of the file is made in a first gallery table associated with the first gallery, causing the storage of the file in a file storage, providing a set of settings options to the file owner comprising at least an options to make the file public and allow the file to be collected, and receiving a request from a user to collect the file into a gallery owned by the user, wherein a record of the file is made in a second gallery table, thereby causing the file to be collected into the second gallery. The file is collected to the second gallery only if the owner has designated the file as public and designed that the file is collectable. Only a single copy of the file is contained in the file storage.

### DRAWINGS

The above-mentioned features and objects of the present disclosure will become more apparent with reference to the following description taken in conjunction with the accompanying drawings wherein like reference numerals denote like elements and in which:

FIG. 1 is a block diagram of an embodiment of a database sharing system;

FIG. 2 is a block diagram of an embodiment of a gallery of a database sharing system;

FIG. 3 is a block diagram of an embodiment of galleries organized in user accounts in a database sharing system;

FIG. 4 is an organizational diagram of an embodiment of gallery sub-tables that are used to build a master gallery table in a database sharing system;

FIG. 5 is an exemplary embodiment of a webpage of a gallery having a plurality of files contained therein;

FIG. 6 is an exemplary embodiment of a webpage of a dialogue box for manually collecting files into a gallery;

FIG. 7 is an exemplary embodiment of a webpage of a gallery in which files have been manually collected;

FIG. 8 is an exemplary embodiment of a webpage that allows an owner to select options for a gallery;

FIG. 9 is an exemplary embodiment of a webpage that allows an owner to select options for a gallery, including options related to rule-based collection criteria;

FIG. 10 is an exemplary embodiment of a webpage that allows an owner to define rules for automatic collection of files;

FIG. 11 is an exemplary embodiment of a webpage that allows an owner to define rules for automatic collection of files;

FIG. 12 is an exemplary embodiment of a webpage of a gallery in which files have been manually collected and collected via rules;

FIG. 13 is an exemplary embodiment of a plurality of database tables used according to the systems and methods of this disclosure; and

FIG. 14 is an exemplary embodiment of a plurality of flow diagrams for processing of the database tables based on the specific action taken by a user.

### DETAILED DESCRIPTION

In the following detailed description of embodiments of the present disclosure, reference is made to the accompanying drawings in which like references indicate similar elements, and in which is shown by way of illustration specific embodiments in which the present disclosure may be practiced. These embodiments are described in sufficient detail to enable those skilled in the art to practice the present disclosure, and it is to be understood that other embodiments may be utilized and that logical, mechanical, electrical, functional, and other changes may be made without departing from the scope of the present disclosure. The following detailed description is, therefore, not to be taken in a limiting sense, and the scope of the present disclosure is defined only by the appended claims. As used in the present disclosure, the term “or” shall be understood to be defined as a logical disjunction and shall not indicate an exclusive disjunction unless expressly indicated as such or notated as “xor.”

As used herein, the term “server” or “servers” shall be understood to mean one or more computers in a network that is used to provide services to other computers in the network, including remote computers.

As used herein, the term “store,” “storage,” and derivates thereof shall be defined based on context: in the context of storage of digital files, the term store shall be understood to mean storage of the digital file on a storage media (e.g., a machine readable or computer readable media), and expressly encompasses storage by a third party storage provider; in the context of storage of files in a repository or database, the term shall be understood to mean storage of an address, link, pointer, or the like of a storage media of the file. Thus, repositories or databases do not directly store digital files, but the store information related to where the digital file is physically located on storage media, as well as other information related to each digital file.

As used herein, the term “gallery” shall refer to a set of files organized in a group. For example, a gallery of photographs is a group of photographs grouped by an event, a date, a location, etc. For example, a gallery of music files could comprise groupings of song files organized according to an album, genres, artist, etc. For example, a gallery of word processing files could be organized by content, by intended recipient, by owner, etc. Galleries of multiple types of files (e.g., photographs, music, word processing, etc.) are expressly contemplated as being included in the definition of a gallery. Moreover, sub-galleries of galleries are likewise expressly contemplated, and comprise a subset of the files in the gallery. Galleries are implemented in a database table, according to embodiments.

As used herein, the term “user” shall be defined to be a person who uses the database sharing system disclosed herein. Accordingly, the term “user” encompasses two subgroups of users, those users who have accounts with database sharing system 1 and are logged in to their accounts, which are referred to as “logged in users” and users who are not logged in to an account with the database sharing system, which are referred to as “browsing users.”

As used herein, the term “owner” is a user that uploads a file to their account with the database sharing system.

As used herein, the term “server” shall be understood to mean one server or a plurality of servers acting in concert with each other.

The inventors of this disclosure developed novel ways to manage content stored in databases. More specifically, the inventors developed systems and methods for causing information, including references to files, which are stored in databases to be more readily shared with other users of the database without the need to create multiple database references to the same object.

The subject matter of this disclosure is applicable to file sharing services, such as online photo galleries. Typically, users upload photos to these galleries in connection with a user account, which permissions the uploaded photos. According to embodiments, to view the photos, they must either be designated as public, or if the gallery is private but another user knows the URL to the gallery, (e.g., the user has a link to a unique URL for the gallery), or the gallery is password protected and the other user knows the password to access the gallery. According to other embodiments, other users must have specific permission to view the photos.

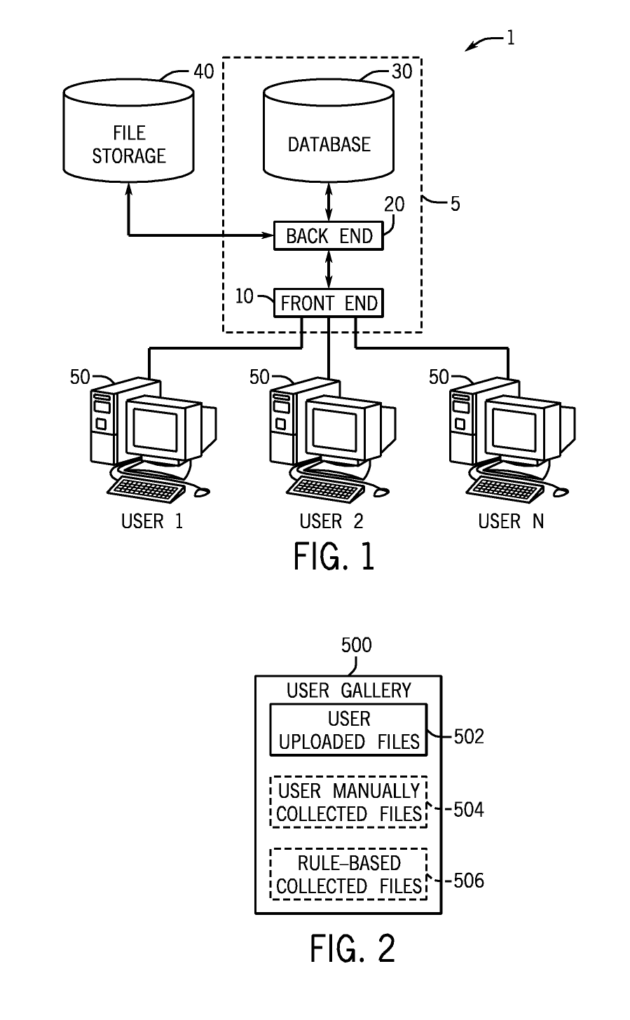

According to embodiments and as illustrated in FIG. 1, database sharing system 1 comprises front-end 10 and back-end 20. Back-end 20 is in data communication with database 30 and file storage 40. File storage 40 can be local file storage or file storage provided by a third party. Users 50 interact with database sharing system 1 via computers, including personal computers, smartphones, tablet computers, or other machines that have the required connectivity and are able to provide an interface for interaction with database sharing system 1. According to embodiments, each user account is transparent to the other user accounts, whereby the content in each owner's 50 account or galleries is confidential from the other users 50, unless each owner 50 specifically makes galleries that are part of the account public, or makes the gallery private and gives other users the URL, or password protects the galleries and provides other users with the access password. According to other embodiments, owner 50 authorizes one or more other users 50 to view at least some of the content in the account.

According to embodiments, front-end 10 comprises an interface through which users 50 interact with database sharing system 1. According to embodiments, front-end comprises web-pages hosted on a webserver that makes up part of back-end 20. As such, users 50 are able to view, download, or browse files using front-end, as well as upload new files to database sharing system 1. Additionally, owners 50 are able to permission their files, whereby other users are able to view, download, or browse the newly permissioned files.

According to embodiments, server 5 comprises back-end 20, front-end 10, file storage 40, and database 30. According to embodiments, the server comprises at least a web server, for example an Apache web server or Internet Information Services (IIS) web server. The server facilitates remote data communication with users 50 via the web server, according to embodiments. Artisans will generally recognize that each of server 5, back-end 20, and front-end 10 are servers; the division into server 5, back-end 20, and front-end 10 exist to describe functional aspects of the present disclosure, but actual implementations each of these devices may reside on one or more computers the can be generally defined as a server. Moreover, file storage 40 is defined above in the context of server 5, but may actually be a third party storage such as Amazon Simple Storage Server (Amazon S3), for example, which would have its only protocol (e.g., and application programming interface) for storing and retrieving files that can are implemented by server 5 to cause storage and cause retrieval of files, according to embodiments. According to some embodiments, files are stored directly to third party storage when a user uploads or downloads the file (i.e., the user will upload or download the file directly to or from the third party storage) and server 5 will store a link in the database with the location of the file in the third party storage or will otherwise be able to determine the location of the file in the third party storage using metadata or other stored information.

According to embodiments, server 5 communicates with database 30. According to embodiments, server 5 supports server side scripting, for example PHP: hypertext preprocessor (PHP), for access of the data to be written to or contained in database 30 and also for dynamically presenting data as part of webpages to users 50.

According to embodiments database 30 is implemented as part of database sharing system 1. Database 30 is the central hub for all the data to be collected, stored, and processed. It is also a location from which data is retrieved. Database 30 is an organizational tool for organizing and managing the files that comprise galleries 500. Database 30 may be implemented as a SQL database, MYSQL database, Oracle database, or a proprietary database, for example. Use of other commercially available or specially implemented databases are expressly contemplated. According to other embodiments, database 30 is developed specifically for management of, organization of, and facilitating access to files stored in file storage 40. Generally, database 30 must be able to store and retrieve large volumes of data and likewise provide access to large volumes of data. According to embodiments, database 30 stores only a link or pointer to actual files that are stored in another location.

According to embodiments, files are organized into galleries. Each file in the gallery is stored in file storage 40 when it is uploaded. For each file uploaded, a database record for that file is made in database 30. According to embodiments, each database record comprises basic information about the file such as the name of the file, the path of the file in file storage 40, the owner of the file, the date it was uploaded, and other meta data information about the file, for example. According to embodiments, each database record is a row or column of one or more gallery database tables.

Additionally, each database record comprises file permissions that define for user's privileges with respect to the file. According to embodiments, the owner always has full access for the file. According to embodiments, the owner may permission the file such that certain logged in users can access the file, or that browsing users can access the file (e.g., permission the file so that it is public).

According to embodiments, files are permissioned via gallery-wide permissions. Rather than permissioning each individual file, the owner permissions each gallery 500. All files in gallery 500 therefore inherit the gallery-wide permission set.

According to embodiments and as illustrated in FIG. 2, owner 500 has three ways to populate gallery 500 with files. First, user uploaded files 502 are uploaded to the gallery directly by the owner. Second, user manually collected files 504 comprise files from other galleries from which the user has collected files from. According to embodiments, files are manually collected from another of the owner's galleries or from files located in other user's gallery. To collect from another user's gallery, according to embodiments, the owner must be able to access the gallery as described above and the other user must allow for collection of the file or files the owner wishes to collect. According to other embodiments, the owner must have permissions from the user to collect the files. Lastly, rule-based collected files 506 are files that are collected by rules determined by the owner. To use rule-based collection, the owner must have access to the files, as described above and the files that are to be collected my be collectable, according to embodiments. According to other embodiments, the owner must have access to the files and be permissioned to collect the files. Database sharing system 1 executes the rules and finds files that match the criteria set by the rules and populates the files matching the criteria in the user's gallery.

According to embodiments, owner 50 uploads files to database sharing system 1 according to methods that are well known and understood by artisans. For example, the user can use a webpage that allows the user to browse for a file and upload the file to a server, for example a web server, comprising part of database sharing system 1 via HTTP, FTP, or other common proprietary protocols allowing for file sharing. The server routes the file to file storage 40 and causes a database record to be made for the file, as described in greater detail below. According to embodiments, stand alone uploading software may be installed to the owner's computer and facilitate uploading files from the owners computer to the server. Such software may be proprietary, such as a web browser plug-in or application that communicates solely with the server of database sharing system 1, or it may be a general purpose software, such as an FTP client. Upload via HTTP, FTP, and other well known or proprietary protocols useful for transferring files are expressly contemplated.

According to embodiments, user manually collected files 504 are collected when an owner of one gallery selects files in another gallery or galleries to include in the one gallery. To manually collect files into a gallery, according to embodiments, a user browses to other galleries and selects those files to be collected into one of the user's own galleries, if the files are collectable. According to embodiments, the user can collect gallery items from one of her other galleries, or from another user's gallery if the user has permissions to access or collect the gallery items, according to the particular implementation of what permissions are required to collect a file.

For example, in the context of photo galleries, as a user navigates to photos that the user likes, she clicks a collect icon and is prompted to add the photos to another gallery she owns. For example, a first user and a second user both go to Disneyland. The first user took photos of the Pirates of the Caribbean ride and the second user shot Big Thunder Mountain ride.

When they return, they both upload their photos to their respective galleries on database sharing system 1. The second user wants to have the photos from Pirates of the Caribbean in his Disneyland gallery. According to the traditional model, he would download the original from the first user's gallery to his hard disk and then upload it to his gallery. Accordingly, database sharing system 1 would then cause storage of two copies of the same photo. Moreover, if the first user makes a modification to the photo, such as cropping his version or removing the red-eye from his version, it will look different from the version that the second user downloaded from the first user's gallery and reuploaded to his own gallery.

However, using the systems and methods of this disclosure he would avoid the redundant photo storage in storage device 40, according to embodiments. The second user could navigate to the first user's Disneyland photos and collect one or more of them to his Disneyland gallery. By manually collecting the photos, database sharing system 1 retains only a single copy of the photo, but with database links to show the photo in both the first user's Disneyland gallery and the second user's Disneyland gallery. If the first user, who owns the photos decides to crop it, for example, the photo appearing in the second user's gallery will be the cropped version.

According to embodiments, database sharing system 1 attributes or otherwise displays features and permissions that accompany collected photos according to the settings of the owner. For example, if an owner of a file that has been collected to another user's gallery decides to make the file private, or to specifically exclude the other user's access to the photo, then the photo will no longer appear in the second user's gallery.

According to embodiments, rule-based collected files 506 are files that are automatically added to a gallery based on rules defined by the owner of the gallery. According to embodiments, a file can only be collected to a gallery having rule-based collection if that file could be manually collected to the gallery (i.e., the gallery owner can access the files and the files are collectable).

According to embodiments, rule-based collected files 506 are collected according to rules defined by the owner of a gallery. For example, the owner can define rules such as specific users to collect from; specific galleries to collect from; keywords, where the files collected contain or are tagged with the keywords; specific time periods from which to collect; geographic locations from which to collect; and combinations thereof; etc. Artisans will readily recognize that this list isn't exclusive, and other rule-based criteria are expressly contemplated.

For example, if the second user uploads his Big Thunder Mountain Disneyland photos, he can collect other's Disneyland photos by defining collection rules, which will automatically seek out photos in other galleries that match the criteria defined in the rules by the second user. For example, his rules could define the first user's galleries as the place to collect photos from and to collect only photos tagged with “Disneyland” or the term “pirates” if he wants to automatically collect the first user's Pirates of the Caribbean photos.

Moreover, once the collection rules are set, the collection process allows users to “monitor” other user's galleries to collect photos that haven't yet been uploaded to database sharing system 1. Thus, if the first user posts 20 Disneyland photos, but holds on to ten of his Disneyland photos locally to do some retouching and later posts those to the gallery two weeks later, the rule-based collection will eventually contain all 30 Disneyland photos irrespective of when the first user uploaded them. Contrastingly, if the second user was manually collecting the Disneyland photos, he would have to visit the first user's gallery on two occasions, after each batch of Disneyland photos were uploaded, to collect all 30 photos.

According to embodiments, various gallery settings must be met before files are can be collected either manually or via rule-based collection. According to embodiments, the first criteria that must be met is that the user trying to collect files from the gallery must be able to access the files. According to embodiments, the gallery must be public for the files to be collected. Collectability for other protection schemes is similarly contemplated, provided that the user attempting to collect files has access to the files that are to be collected. According to other embodiments, the user must be permissioned with access privileges.

According to embodiments, the second criteria is the owner of the files that are being collected must expressly designate the gallery or the files in the gallery to be “collectable.” According to embodiments, the owner of the gallery can give access to the files to another user, while still controlling whether the users who access the files are allowed to collect the files to other galleries. Thus, for another user to collect files, the files in the gallery must be collectable for a user, in addition to allowing the user to access the files (e.g., by making the gallery public, giving the user the URL, or giving the password of a password protected gallery to the user) or providing the user with the specific access privileges. According to embodiments, a default setting is set on a per gallery basis whereby the content in the gallery is not collectable by default. According to other embodiments, files in a gallery are collectable by default. Generally, owners may wish to make their content public or otherwise provide access to the files without allowing other users to collect the files in the gallery. Thus, according to embodiments, collection of files requires both access to the files and files that are collectable. However, according to alternate embodiments, only access privileges or only collection privileges are required to collect files from one gallery to another gallery. According to embodiments, the owner of a gallery can also collect from other galleries that he owns.

According to embodiments, galleries can be public, but protected with other forms of security such as passwords, etc. In such cases, the files in these galleries cannot be collected, unless the user has access to the galleries, for example, by knowing a password to a password protected gallery. According to embodiments, a private gallery can be password protected, in which a user seeking to access the gallery must know both the URL of the private gallery and the password to access the gallery.

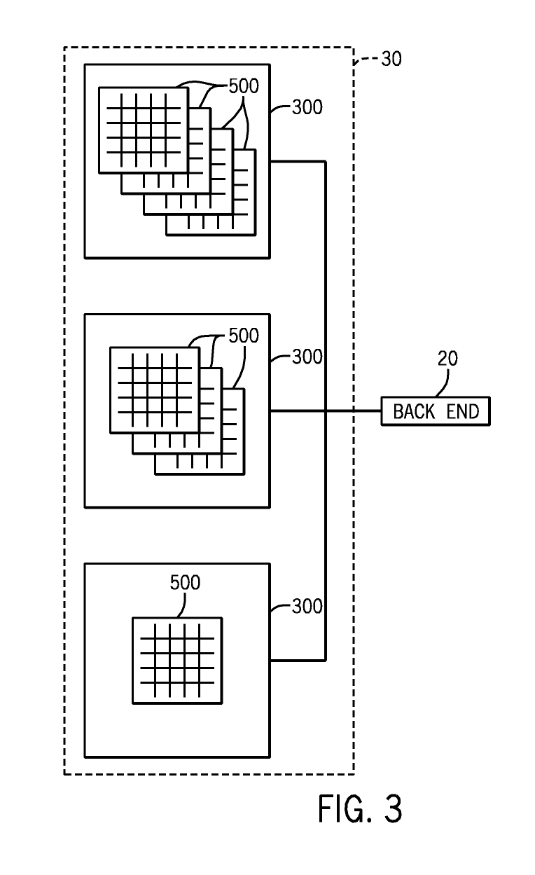

According to embodiments and as illustrated in FIG. 3, a plurality of user accounts 300 comprise one or more galleries 500. Each user account and its galleries are hosted on back-end 20, which comprises a server in data communication with database 30 and file storage 40.

According to embodiments, each gallery comprises one or more database tables. The tables contain at least information related to each file that comprises the gallery. According to embodiments, the tables comprise a record for each file in gallery 500. At a minimum, each record comprises a path in file storage 40 where each file is stored. According to embodiments, other data is stored in each record including, e.g., the name of the file, the date the file was created, the date the file was uploaded, the date the file was modified, file permissions, metadata related to the file (e.g., for a photograph the metadata includes EXIF data, or for a music file the meta data might include ID3 tag data). Gallery specific data are also embedded in the gallery 500 tables, including a title for the gallery, and options or settings, e.g., if the gallery is public or private, if the contents of gallery 500 is collectable, etc. For each gallery in user account 300, the same or different options or settings are defaulted.

Users 50 use a computer terminal to download content via front-end 10. For example, front-end 10 serves dynamic webpages that display the contents of a gallery to users 50. Users can click on icons representing each file to select the file or display the contents of a file in the gallery. When such an event occurs, front-end 10 causes back-end 20 to query the gallery 500 tables to locate the file or access it in some way, e.g., download it, display the file, play the file, etc., depending on the type of file.

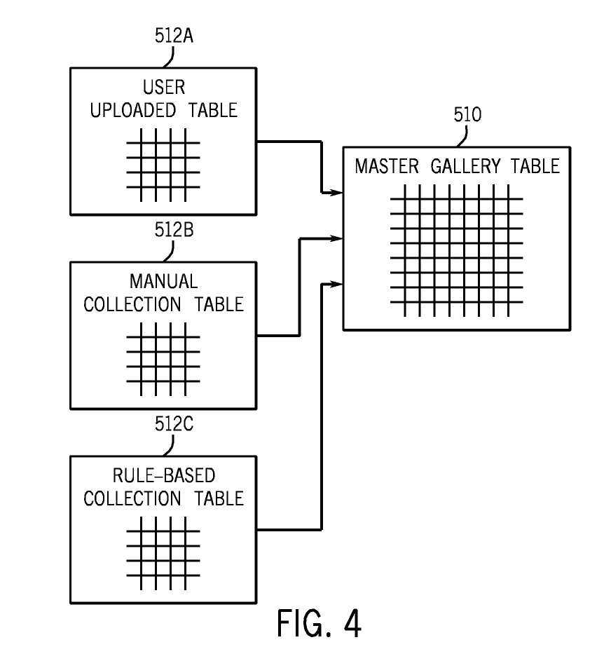

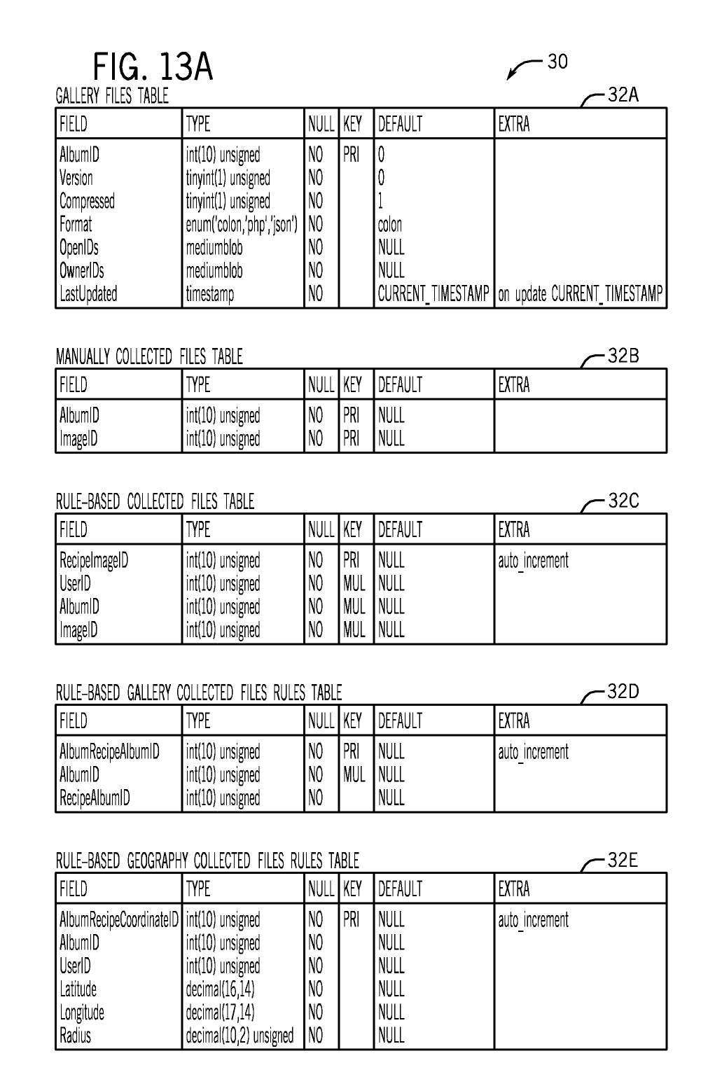

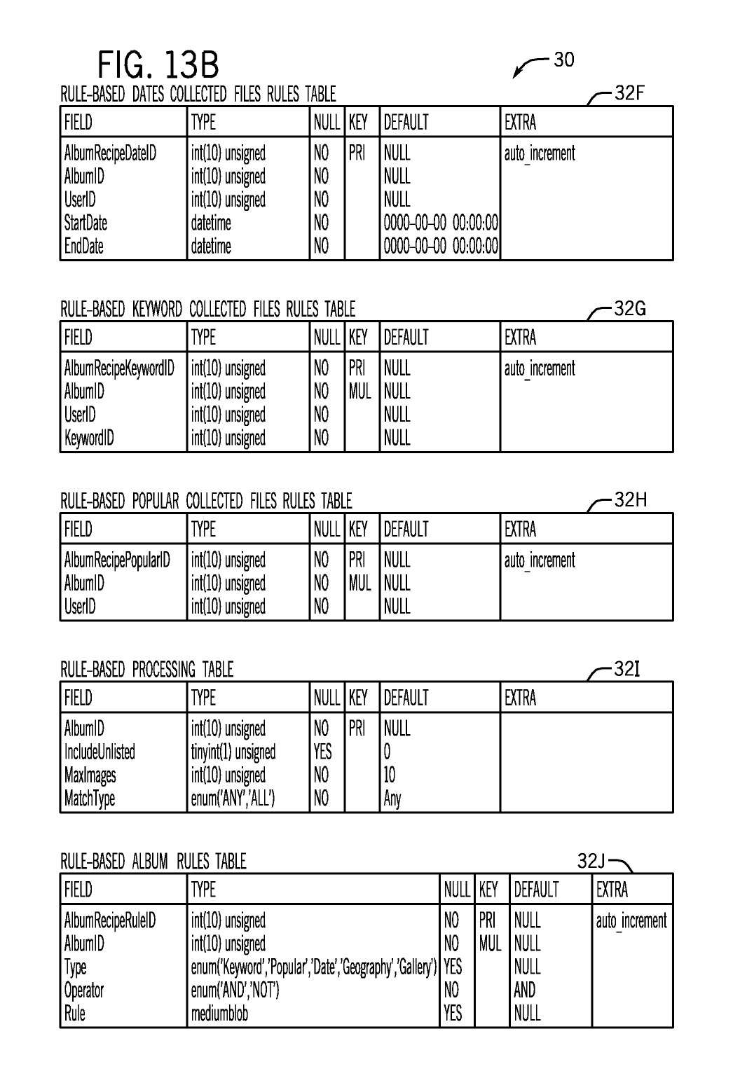

According to embodiments, FIG. 4, illustrates embodiments of database table where files from other galleries have been collected into the gallery. A plurality of gallery sub-tables 512A, 512B, 512C are employed to populate a “master” gallery table 510. According to embodiments, each gallery sub-table 512A, 512B, 512C is used to populated master gallery table 510. For example, user uploaded gallery sub-table 502A, manual collection gallery sub-table 512B, and rule-based collection gallery sub-table 512C each comprise one or more file records or sub-tables having records. Each of these records for each of these gallery sub-tables 512A, 512B, 512C are imported into master gallery table 510. Master gallery table 510 is then used as the primary table that back-end accesses to populate with files into gallery 500 for users 50 to view on their computer. Artisans will recognize that the architecture described above are simplified for clarity in describing the novel features of this application. An actual implementation of the tables is illustrated in FIG. 13 and described in detail in the Examples.

According to embodiments, user uploaded gallery sub-table 512A comprises records for files that are manually uploaded to database sharing system 1 by an owner. This gallery sub-table is updated each time that new files are uploaded into gallery 500 by an owner. Consequently, user uploaded gallery sub-table 512 remains relatively static until the user takes an action to upload files or delete previously uploaded files.

Likewise, manual collection table 512B is updated when a user manually collects files to their gallery. Naturally, therefore, manual collection gallery sub-table 512B comprises records for files that have been manually collected by the user. According to embodiments, this table is updated each time that the user collects new files into the gallery. However, unlike uploaded gallery sub-table 512A, this table is automatically updated periodically to account for actions taken by the owner of the files collected. According to embodiments, a queue system, for example as disclosed below, is used to propagate changes made to this sub-table. For example, if the owner of a file that is collected into the user's gallery decides that she no longer wishes to allow the file to be collected, the change in the file permissions will be filtered to the gallery tables for the galleries that have collected the file so that the record can be removed from those manual collection gallery sub-table 512B, and consequently from gallery 500.

Rule-based collection sub-table 502C is also updated automatically periodically. Rule-based collection table 502C comprises records for files the have been automatically collected according to rules defined by the user. Immediate updates to this table are made, according to embodiments, any time the rules defining the records collected into rule-based collection sub-table 502C are changed. According to other embodiments, this table is updated according to a queue system, for example according to the queue process disclosed herein.

Whenever any of gallery sub-tables 512A, 512B, 512C are updated, they are then used to populate or repopulate the fields of master gallery table 510. Consequently, master gallery table 510 reflects the most current state of each of gallery sub-tables 512A, 512B, 512C at any given time. According to embodiments, there will be a lag for changes to manual collection gallery sub-table 512B's and rule-based collection table 512C's automatic processes for purposes of efficiency in some implementations that manage large numbers of user accounts or galleries. According to smaller implementations, updating of master gallery table 510 occurs contemporaneously with any change made to manual collection gallery sub-table 512B or rule-based collection gallery sub-table 512C. Updating of master gallery table 510 or any other table comprises replacing a record or row for that table, according to embodiments.

According to embodiments, server 5 maintains a queue that processes rules for rule-based collected files, or for updating changes to previously collected rule-based collected files or manually collected files. The queue runs periodically, depending on the particular implementation and the volume of changes that must be filtered to each manually collected gallery sub-table 512B or rule-based gallery sub-table 512C. Depending on the volume or other factors, the queue will run all the time, and will pick up new rules in batches.

According to embodiments, for the queue to efficiently perform its function, each gallery table 500 comprises fields designating whether each file record in gallery table 510 has been collected into another gallery, and which galleries 500 have collected the files. Thus, when database sharing system 1 processes a change to a file or gallery 500, the server will only queue files that have been collected because changes to non-collected files need not be filtered to any other gallery. According to other embodiments, a separate database table is created for galleries 500 that require changes. According to these embodiments, such a table may specify the gallery that must be updated as part of each record or the specific files that must be updated, as well.

Likewise and according to embodiments, each gallery table 510 that has collected at least one file from another gallery 500 contains a field for each record indicating the origin of the file (e.g., data related to the gallery that “owns” the file, the owner of the file, or etc.). According to embodiments, each gallery table 510 also contains a field for each record that indicates whether the record was collected manually or via rule-based collection. According to alternate embodiments, each gallery table 510 that has collected at least one file from another gallery 500 does not need to contain a field for each record indicating the origin of the file. Rather, because each file and each album have unique identifiers, according to embodiments, the owner of the original file will be discovered in a specific user uploaded gallery sub-table 502A. In other words, because the only record for a file in user uploaded gallery sub-table 502A is for an album associated with the owner, in some embodiments adding a field for each record indicating the origin of the file is redundant. Thus, for a given file having a unique identifier, the owner of the file can always be determined by lookup in user uploaded gallery sub-table 502A.

When the source file contained in the file storage 40 is modified, whether the file is queued depends on the type of modification that occurs, according to embodiments. According to embodiments, changes to the file itself, e.g., modification to the contents of the file, need not be queued. For example, a word processing document may have new text entered or deleted, a photo may have color balances adjusted, or a music file may be normalized. These types of changes result in a modified file in file storage 40, but do not result in any modification to a record in database 30. Conversely, if the metadata or a keyword for a photo is updated, or the tag (meta data) of a music file is adjusted, corresponding changes are made to the record in gallery table 510 that “owns” the file. When these types of changes occur, then they must be filtered to master gallery table 510 that have collected these files and the file is placed in queue to be updated. According to embodiments, changes are filtered to the respective gallery sub-tables 512B and 512C which are then used to rebuild master gallery table 510.

According to embodiments, the queue comprises a list of galleries that must be updated. Thus, they are put into “line” for database table changes to be filtered to each database table linking to that record or file. For example, assume a user uploads a photo of a puppy to a gallery. The user designates the puppy photo to be both public and collectable. Thereafter, a second user collects the puppy photo to his “Breeds of Puppy” gallery. The action of collection causes server 5 to copy aspects of the file record in original master gallery table 510 for the puppy file into the second user's manual collection table 502B. Server 5 recognizes that a change has been made to manual collection table 502B as some point soon after the second user collects the puppy file to his gallery. According to embodiments, the second user's master gallery table 500 is updated by creating rows (i.e., record) for the file record of the puppy that is now present in second user's manual collection table 502B. Likewise, if second owner loses access to the puppy photo, the changes will be queued for the file and any galleries that have that file collected will have the row (record) removed for that file, thereby causing the file not to appear in the second user's “Breeds of Puppy” gallery. According to other embodiments, the second user's master gallery table 500 is discarded and a new master gallery table 510 is created from user uploaded gallery sub-table 502A, manual collection gallery sub-table 502B, and rule-based collection gallery sub-table 502C.

According to embodiments and depending on the implementation, certain changes, such as caption changes or other cosmetic-type changes are not filtered to collected files. According to these embodiments, only changes such as a change in the settings of a file to public or collectible would cause the file to be queued for filtering to galleries that have collected the file.

For example, assume that the first user improves the color balance in the puppy file. When the first user makes the modification via front-end 10, the modified file is saved in file storage 40 with the same file name and path. No database records are updated with this sort of change. Consequently, when second user, who has collected the puppy file, opens his gallery, back-end will look at second user's master gallery table 510 for that file and will be directed to display the puppy file by displaying the file from file storage 40. The puppy file displayed will have the color balance changes made by the first user. Thus, for certain changes, each gallery that has collected comprises an updated version of the file by virtue of its being saved with modifications in file storage 40 and when accessed with the modification intact.

Assume that first user modifies the keyword of the puppy file, which causes a change to the files record in master gallery table 510 that owns the puppy photo. Accordingly, when the modification is made, server 5 checks the master gallery table 510 record for the puppy photo and sees that it has been collected into the second user's gallery. However, the second user's gallery contains a record version of the puppy file with the original caption. According to embodiments, database sharing system 1 is designed to exactly mirror the file as it appears in master gallery table 510 that owns the file. Consequently this change must be filtered down to all collected versions of the puppy file. Therefore, the queue receives a request to update each gallery that has collected the file by modifying appropriate gallery sub-table, 512B, 512C, which then causes master gallery table 510 to be modified. Server then causes, according to this example, manual collection gallery sub-table 502B to be modified with the updated record of the puppy file by removing the prior puppy file record and replacing it with a new puppy file record.

According to alternate embodiments, server 5 maintains a plurality of queues. Each queue performs a different task and runs periodically on its own schedule. For example, database sharing system 1 comprises three queues: an files queue, a gallery queue, and a user queue. The user queue handles account level tasks such as passwords, user-specific options, and so forth. Artisans will readily appreciate the metes and bounds of user queue implementation and use.

According to embodiments, the files queue is used to filter image changes to galleries that have collected a specific image. For example, if the metadata of an image or music file changes (e.g., the caption changes, etc.), the files queue will determine which galleries have collected the changed image and will cause manual collection gallery sub-table 502B or rule-based collection gallery sub-table 502C to be modified with updated image records (including deletion of image records), and consequently master gallery table 500 to be modified with the updated image records.

According to embodiments, the gallery queue is invoked when changes to an actual gallery have been made that affects one or more collected files. For example, in first user's gallery, first user decides that she doesn't want files in that gallery to be collectable any longer. She therefore changes the gallery settings and designates the files therein to be non-collectable. Accordingly, the change to the collectibles must be filtered down to galleries that have collected the images that are no longer collectable.

### EXAMPLES

### Example 1

### Manual Collection of Gallery Files into Another Gallery

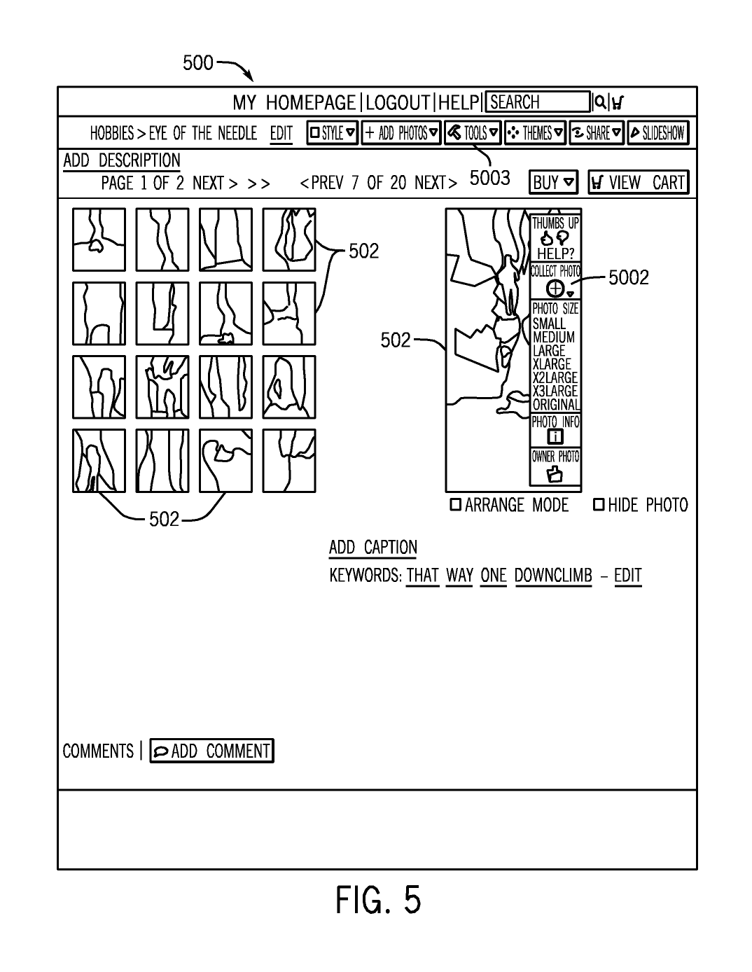

According to embodiments, a gallery comprises a plurality of photograph files. FIG. 5 illustrates an exemplary embodiment of a first gallery that the owner of a second gallery browses to. As illustrated, a plurality of user uploaded photograph files 502 exist in the gallery, which is implemented on server 5. On the right side of the gallery illustrated in FIG. 5, single user uploaded photograph file 502 is shown, together with a menu of options for that particular photograph. Artisans will readily appreciate manually collected files 504 and rule-based collected files 506 could be shown as part of this gallery as well, provided that the files desired to be collected meet the requisite criteria for collection into another gallery.

Among the options presented to the viewer of the first gallery is the “Collect Photo” option 5002. Selecting this option allows the viewer of the gallery to collect that photo into another gallery owned by the viewer. According to embodiments, the photograph or gallery must have an option enabled that allows the photograph or photographs in that gallery to be collected; otherwise “Collect Photo” option 5002 is not presented to the viewer. According to embodiments, the owner of the first gallery will always have the option to collect photos into another gallery owned by the owner, irrespective of the permission set for collection by other users.

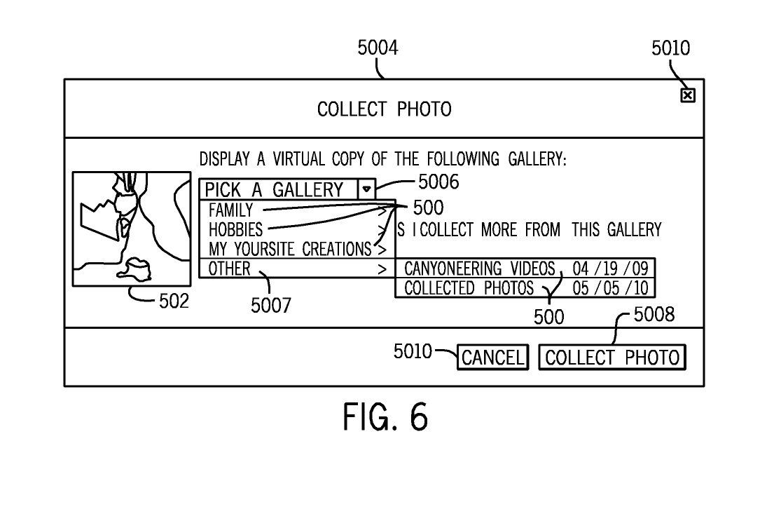

Upon selection of “Collect Photo” option 5002, the viewer is prompted to select one of her galleries in which to collect the photo. FIG. 6 illustrates an exemplary embodiment of dialogue box 5004 prompting the viewer to select second gallery 500 in which to collect user uploaded photograph file 502. Within exemplary dialogue box 5004 is “Pick a Gallery” button 5006. When “Pick a Gallery” button 5006 is selected, dropdown list 5007 appears, which shows a list of second galleries 500 owned by the viewer. The viewer selects from among second galleries 500 presented. Upon selection, the selected gallery 500 is highlighted—in this case “Collect Photos” gallery 500 is selected.

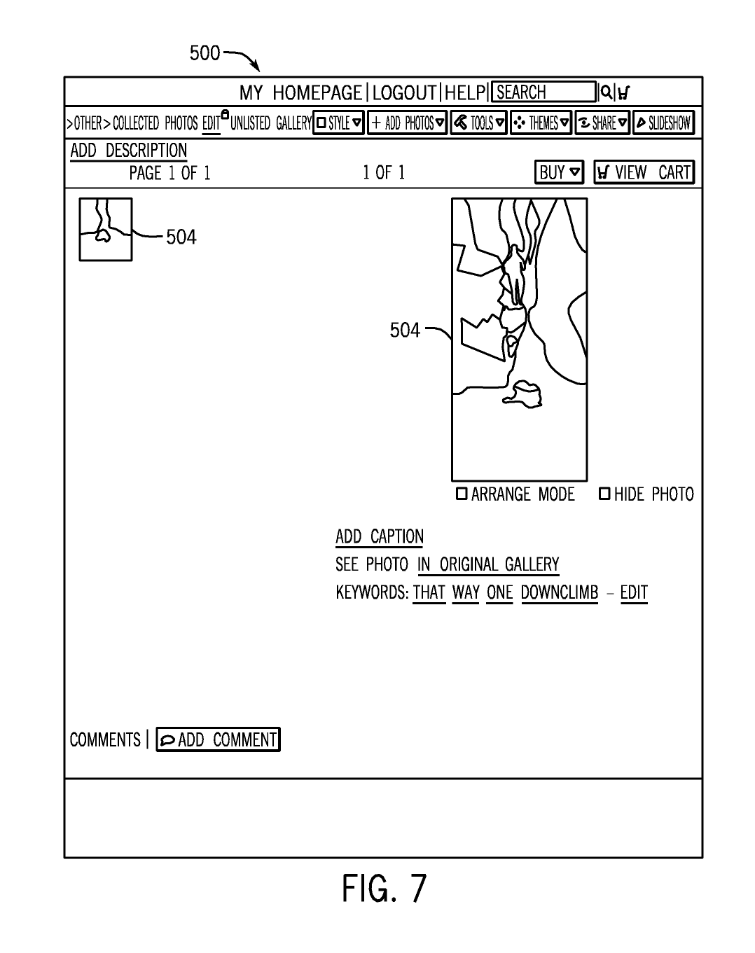

Thereafter, the visitor selects “Collect Photo” button 5008, which closes dialogue box 5004 and collects the user uploaded photograph file 502 to selected second gallery 500, in this case “Collected Photos” gallery 500. As illustrated by an exemplary embodiment in FIG. 7. As illustrated in FIG. 7, which is an embodiment of a second gallery 500 entitled “Collected Photos” owned by the visitor to first gallery 500, the manually collected photograph file 504 is now shown in visitor's “Collect Photos” gallery 500. According to embodiments, visitor may make database-based changes (and only to the database record in his gallery) to collected manually collected photograph file 504, such as changing the caption or adding keywords, but will only be allowed to change manually collected file 502 itself if permissioned to do so by the owner of manually collected file 504 because only a single copy of manually collected photograph file 504 exists on in file storage 40.

Turning again to FIG. 6, if the visitor decides they would rather not collect the user uploaded file 502 after opening dialogue box 5004, the user simply selects the cancel button 5010 (either “Cancel” or “X”) by clicking on it, which causes dialogue box 5004 to disappear without collecting the user uploaded file 502 to any of viewer's galleries 500.

Artisans will readily appreciate that embodiments exist wherein upon selection “Collect Photo” option 5002 illustrated in FIG. 5, no dialogue box 5004 will appear, but the photo will be directly collected to a default collection folder, such as a “Favorites” folder. Accordingly, dialogue box 5004 does not appear, neither will an option of which gallery 500 to collect user uploaded file 502 be presented.

### Example 2

### Gallery Specific Settings Allowing For Files to be Collected into Another Gallery

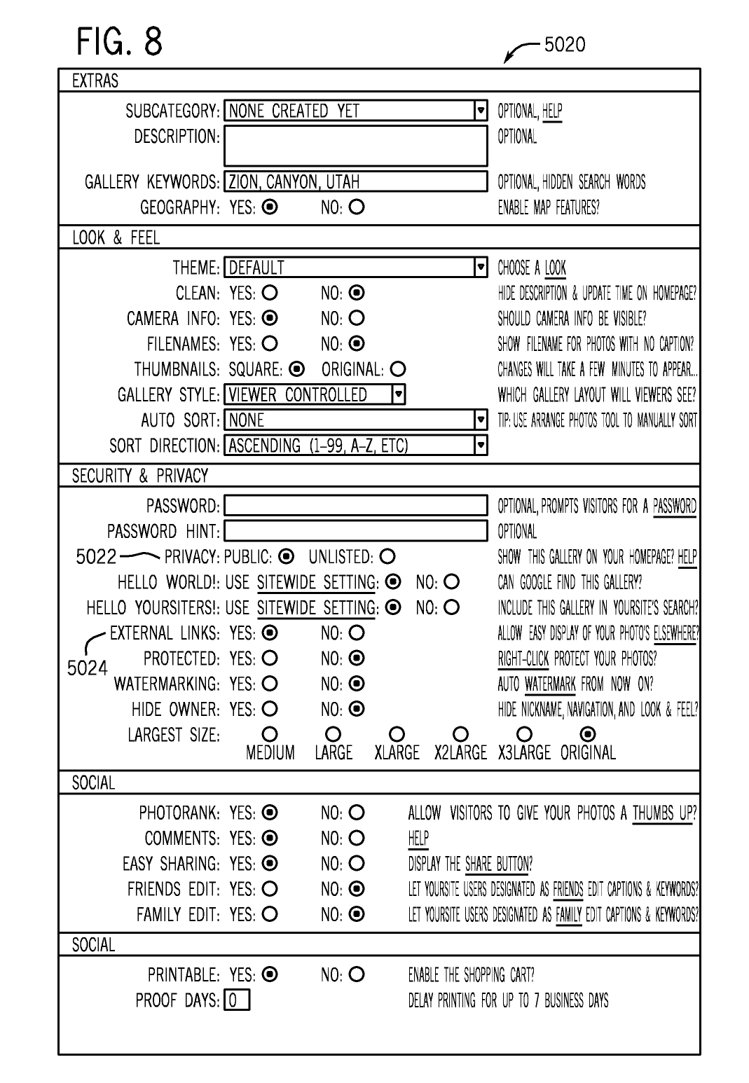

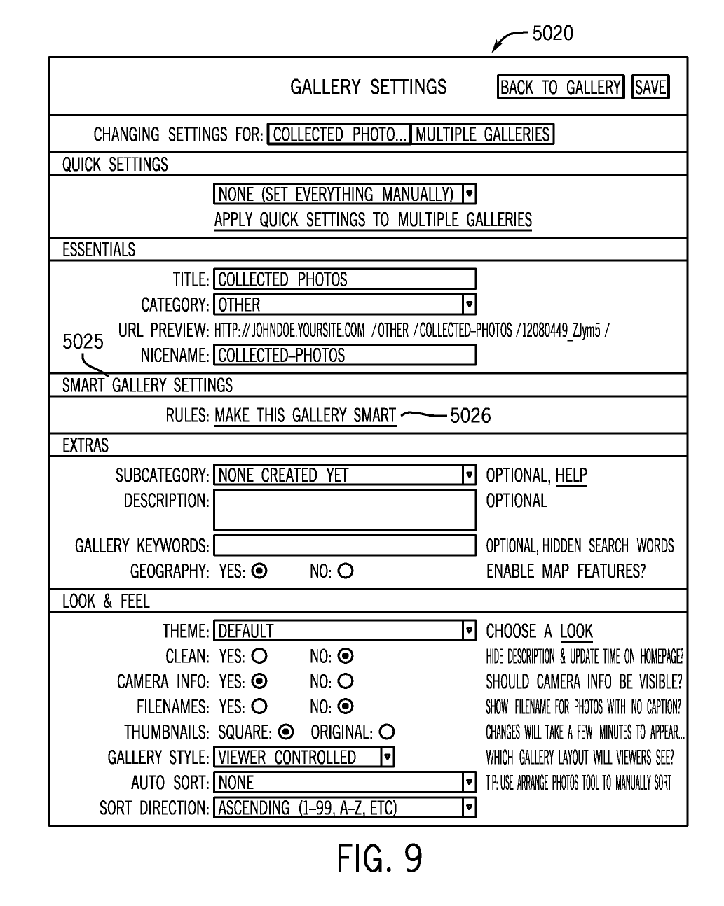

As illustrated in an exemplary embodiment disclosed in FIG. 8, there is shown gallery specific settings options 5020. FIG. 9 shows additional options available in the exemplary embodiment. Reaching an options page is accomplished by selection of a gallery specific option, for example “Tools” option 5003, illustrated in FIG. 5.

To make files 502, 504, 506 collectable in the exemplary gallery options shown in FIG. 8, a user must make the gallery both public and make the gallery collectable according to embodiments. According to the exemplary embodiment, gallery 500 owner can select Privacy Option 5022 by clicking on one of two radio buttons: “Public” or “Private.” According to embodiments, each of owner's galleries 500 default to “Private” or the owner sets an account-wide default gallery setting that applies to all newly created galleries 500. According to other embodiments, each of owner's galleries 500 default to “Public.” Irrespective of default settings, the owner may override the default setting by selecting either the “Public” or “Private” radio button under Privacy Option 5022.

According to the exemplary embodiment illustrated in FIG. 8, an owner further makes files 502, 504, 506 in gallery 500 collectable by enabling External Links option 5024, which allows a public link for each file 502, 504, 506 in gallery 500 to be created whereby each file 502, 504, 506 comprises a unique internet uniform resource indicator (URI). I.e., this setting makes the files collectable. According to other embodiments, External Links option 5024 is enabled when the owner selects the “Yes” radio button. According to embodiments, External Links are automatically enabled or disabled by default.

### Example 3

### Rule-Based Collection of Gallery Files into Another Gallery

According to an exemplary embodiment and as illustrated in FIGS. 9-12, users can also populate galleries with rule-based collected files 506. Rule-based collected files 506 can be used to populate galleries 500 that already contain user uploaded files 502 or manually collected files 504, or can be used to populate empty galleries.

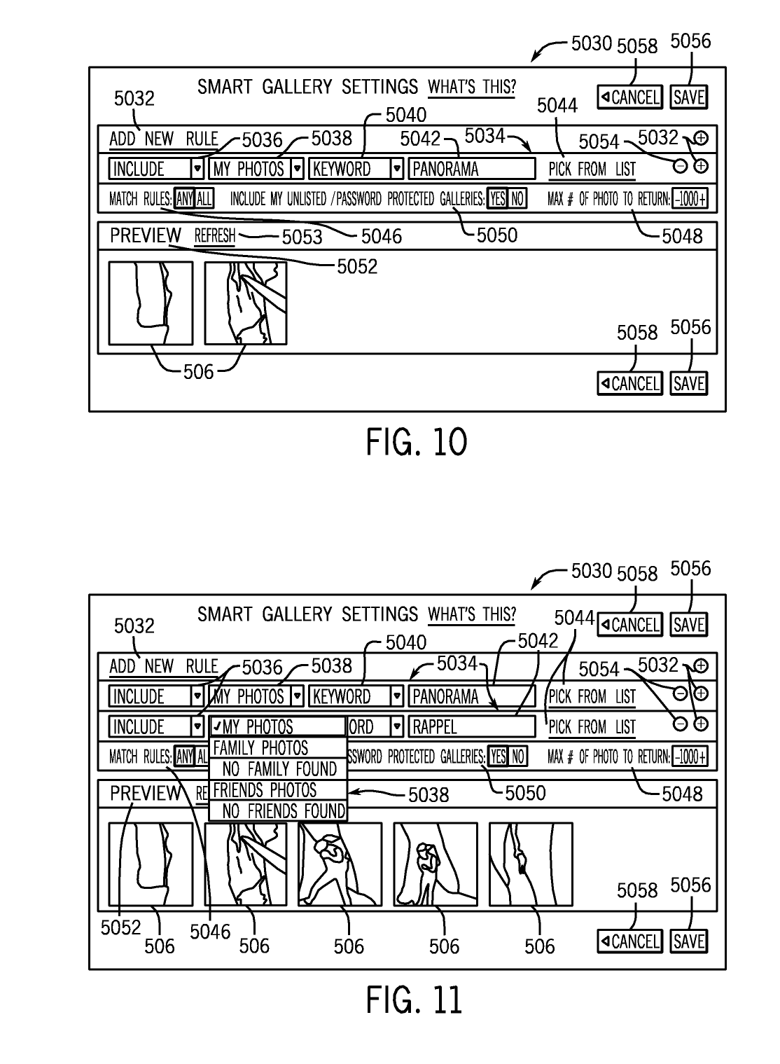

According to the exemplary embodiment, FIG. 9 illustrates gallery specific settings options 5020. As illustrated, “Smart Gallery Settings” heading 5025 allows the gallery's owner to select rules that collect rule-based collected files 506 into that gallery. For example, under the “Smart Gallery Settings” heading 5025 is a “Make this Gallery Smart” link for setting rules used to collect files. The owner of the gallery selects this link by clicking on it, which opens “Smart Gallery Settings” dialogue box 5030, illustrated by an exemplary embodiment in FIG. 10.

According to the exemplary embodiments, “Smart Gallery Settings” dialogue box 5030 comprises options for creating rules that locate and populate the user gallery 500 with rule-based collected files 506. As illustrated, the user uses the “Add New Rule” option 5032 to add a new rule by clicking on it. Once clicked, it opens up rule dialogue 5034, which comprises a set of options that are settable for the rule.

Inclusion option 5036 allows the owner to dictate whether the rule includes files meeting the criteria or excludes them. According to the exemplary embodiment, when a user clicks on the inclusion option 5036, a drop down list shows an “Include” option (shown as the default option in FIG. 1D) or an “Exclude” option. Selection of the “Include” option means that files meeting the criteria defined in the rule will be included in the collected set of rule-based collected files 506, whereas selection of the “Exclude” option means that the files meeting the criteria will not be included in the collected set of rule-based collected files 506.

Source option 5038 allows the user to specify the sources from which to collect rule-based collectable files 506 embodiments, the owner specifies one or more friends or family members in which to search for the files matching the rule.

To make the selection, the user clicks on the source option 5038. A drop down menu is shown with a list of friends and families, for example. The user may then highlight and select a specific friends or family user, which user's collectable files would then be included in the set of files to search for matches to the rule. If the user wishes to select additional friends or family users, the owner repeats the process, selecting each additional friend or family user desired. Each time a user is selected, it is toggled whereby on subsequent clicks on Source option 5038, the previously selected users are indicated with a mark, such as a check mark (see, e.g., FIG. 11).

Rule criteria option 5040 allows the owner to indicate what the rule will define. For example and according to the exemplary embodiment, an owner has the option to select one of “Keyword,” “Date,” “Popular,” “Geography,” or “Gallery.” For each rule criteria option 5040 selected, the owner will also input data into rule criteria field 5042 that defines the matching criteria.

The “Keyword” option is used to collect files having the same keywords associated with it as the keyword(s) input into rule criteria field 5042 by the owner.

The “Date” option is used to collect files within the date or date range input into rule criteria field 5042 by the owner. According to embodiments, because multiple dates can be associated with a file, such as the creation date, modification date, and upload date, the owner has the option to select which date is matched by the rule. For example, if a user wants to find all his friend's 2009 Leadville 100 photographs, he might include a date rule for all files created between Aug. 13, 2009 and Aug. 17, 2009.

Selection of the “Popular” option, according to embodiments, doesn't allow the owner to input any criteria into rule criteria filed 5042 (in some embodiments, selection of “Popular” will cause rule criteria field 5042 to disappear), but rather matches files that have a predetermined number of hits or that have been highly rated by other viewers, for example.

Selection of the “Geography” option is used to collect files that are associated with a geographic location, for example files (such as photos) that are associated with GPS coordinates, or music files that were recorded at a given venue. Accordingly to embodiments, when the user selects the “Geography” option, the owner is allowed to input a geographic coordinate and radius size into rule criteria field 5042. According to other embodiments, when the owner selects the “Geography” option, a map is displayed. The user then selects a location within the map. When the location is selected, a circle is shown on the map around the selected location, which can either be increased or decreased in diameter to select a desired range around the selected location.

Selection of the “Gallery” option is used to collect files within specific galleries. This option is closely associated with Source option 5038, and for the sources selected allows the owner to further specify the galleries that they wish to collect files from. Once “Gallery” is selected, the owner either inputs the name of the gallery that the owner wishes to collect from by inputting the name in rule criteria field 5042, or selects the gallery from a list of galleries (which is populated with galleries based on the selections made in Source option 5038).

For each gallery 500 using rule-based collection, multiple rules may be generated. To add a subsequent rule to the list of rules, the owner selects “Add New Rule” option 5032 by selecting the “Add New Rule” button or the Plus button. If the owner decides that a rule is unnecessary, the owner selects the Minus option 5054, which removes the rule in line with the minus, according to embodiments.

According to embodiments, if multiple rules are created, the owner can dictate how files are matched to the rules. In logical operator option 5046, the owner selects how rules must be matched for a file to be a matched. If “Any” is selected, all files that match at least one rule are deemed to match the rules. If “All” is selected, only files that match each and every rule are deemed to match the rules.

According to embodiments, the owner also dictates how many files the rules are permitted to match in Max Files option 5048. Database sharing system 1 will then collect rule-based collected files 506 up to the limit and thereafter no-longer populate the owner's gallery 500 with further rule-based collected files 506 that match the rule criteria.

For example, the user has a brother whose family accompanied the user family on a trip to San Diego, Calif., where both families attended Sea World and the San Diego Zoo. The user wishes to compile a San Diego Zoo gallery for the trip. He therefore uploads his San Diego Zoo photos to his new San Diego Zoo gallery. He also wants to collect his brother's photos into his gallery, so he creates a rule. First, the user might select “Include” as inclusion option 5036, and in source option 5038, he would select his brother as the source. Thereafter, the owner can get the San Diego Zoo pictures in a few different ways. First, in rule criteria option 504, the owner can select “Keyword” and input “San Diego Zoo” into rule criteria field 5042, which will select all of his brother's photos that are tagged with the term “San Diego Zoo.” Another way the user might collect his brother's San Diego Zoo photos is to select “Geography.” The user would then locate the zoo on a map displayed by database sharing system 1 and selects a radius that encompasses the entire zoo. Another way to select the San Diego Zoo pictures is to select the “Gallery” option and select his brother's San Diego Zoo gallery. According to embodiments, the owner can use one, some, or all of these rules simultaneously and select “Any” on the logical operation option 5046.

If the brother has visited the San Diego Zoo more than once, the owner can add another rule to restrict the photos that were taken or uploaded via a date range to further screen the files collected.

At any time, the owner can preview which files the rules will collect in Preview box 5052. To preview, the owner clicks on the refresh link 5053, which causes database sharing system 1 to process the rules and collect rule-based collected files 506 that meet the criteria defined by the rules. Once the owner has completed inputting the rules, the owner selects save option 5056, which saves the settings (including the rules) and causes database sharing system 1 to collect rule-based collected files 506 into gallery 500 in which the rules have been defined. If the owner decides not to save the settings, the owner selects Cancel option 5058, which prevents modification of the settings in “Smart Gallery Settings” dialogue box 5030.

According to embodiments, FIG. 11 illustrates use of multiple rules to select different files. According to the exemplary embodiment, the rules select all photos that have a keyword of either “panorama” or “rappel.” It will be observed that with the addition of the second rule (compared to FIG. 10), additional rule-based collected files 506 are collected as shown in Preview Box 5052.

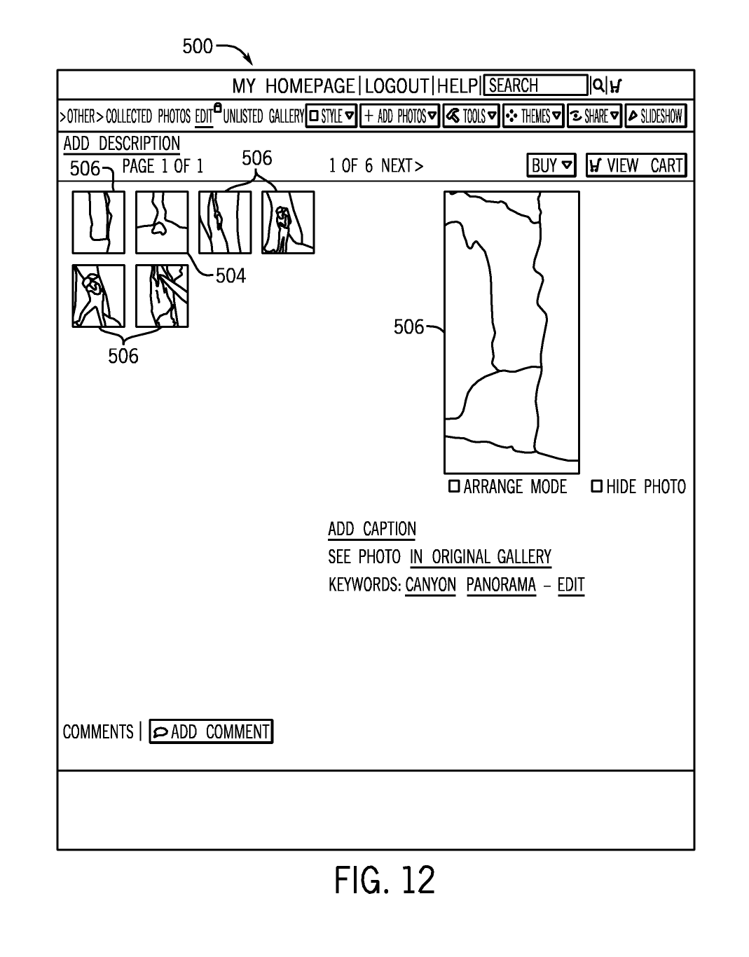

According to embodiments, FIG. 12 illustrates the exemplary gallery of Example 1, with the rules defined in FIG. 11. As illustrated, gallery 500 comprises a plurality of files, including manually collected file 504 and rule-based collected files 506.

### Example 4

### Database Tables

FIG. 13 illustrates exemplary database tables 32A-32J that are used in exemplary database 30. Each table comprises a pluralities for fields (rows) and data for each field (columns).

According to the exemplary embodiment, database comprises tables for images and a table for each gallery, wherein the gallery table references the images in the image table. Implementations of galleries and tables are well known in the art. The following tables comprise an exemplary implementation of additional tables that are specific to the system and methods disclosed herein.

According to the exemplary embodiment, gallery files table 32A is a table that contains file records for all files that have been collected into a gallery. AlbumID comprises a unique identifier of a gallery containing the collected images. The Version, Compressed, and Format fields are fields that are used internally in the database sharing system 1 to provide information that is needed or useful to database sharing system 1 to operate efficiently. OpenIDs is a field that stores one or more unique identifiers of collected images that are available for public viewing; OwnerIDs is a field that stores the unique identifiers of public images and images that only the owner is able to view. LastUpdated is a field that indicates the last time the record for a given images was updated. Artisans will recognize that for a given record, numerous unique identifiers for images can be stored in each OpenIDs and OwnerIDs field, one for each file that has been collected into the gallery.

Gallery files table 32A is supplied with data from uploaded files, and file data from manually collected files table 32B and rule-based collected files table 32C. Manually collected files table 32B contains file records for each file that has been manually collected in a given gallery. AlbumID is a field that contains the unique identifier of the gallery that has the collected files. ImageID is a field that stores the unique identifier of each file that has been collected into the given gallery. Artisans will recognize that in a given record, a plurality of ImageIDs can appear for a single AlbumID.

Likewise, rule-based collected files table 32C comprises data from files that have been collected via rules. RecipeImageID stores a unique identifier for the record. This table adds a record for each file that matches any of the rules. RecipeImageID is a field that stores a unique identifier that the specific rule tables are able to use in the population of this table. UserID is a field that stores the unique identifier of the user to whom the rules belong. AlbumID and ImageID are the same as described in manually collected files table 32B.

Each type of rule, according to the exemplary embodiment, comprises its own table: rule-based gallery collected files table 32D, rule-based geography collected files table 32E, rule-based dates collected files table 32F, rule-based keyword collected files table 32G, and rule-based popular collected files table 32H. Each of these tables defines the rules that database sharing system 1 uses to populate rule-based collected files table 32C. Each of these tables comprises at least an AlbumID field that identifies the album owning rules.

Rule-based gallery collected files rules table 32D comprises two fields in addition to the AlbumID field: AlbumRecipeAlbumID and RecipeAlbumID fields. These fields store unique identifiers for the rule and the unique identifier for the album from which the files are being collected, respectively.

Rule-based geography collected files rules table 32E comprises fields that define geography based rules. AlbumRecipeCoordinateID field stores a unique identifier for the rule record. The UserID field stores the unique identifier of the user from whom the files are collected from. The Latitude, Longitude, and Radius fields store the geographical parameters defining the rule, where the Latitude and Longitude store a point on a map and the radius defines how far from the point a file can be if it is a match to the rule.

Rule-based dates collected files rule table 32F comprises fields that define rules based on a date range from which to collect from a user. AlbumRecipeDateID is a field that stores a unique identifier for the rule. AlbumID and UserID store unique identifiers for the user and the user's album from which the files are being collected, respectively. StartDate and EndDate store dates defining the time range that is used to determine matches to the rule.

Rule-based keyword collected files rule table 32G comprises fields that define rules based on keyword matches. AlbumRecipeKeywordID is a field that stores a unique identifier for the rule. AlbumID and UserID store unique identifiers for the user and the user's album from which the files are being collected, respectively. Finally, KeyWordID is a field that stores a unique identifier of a keyword.

Rule-based popular collected files rule table 32H comprises field that define rules based on collected popular files from users. AlbumRecipePopularID is a unique identifier for the rule. AlbumID and UserID store unique identifiers for the user and the user's album from which the files are being collected, respectively.

Rule-based processing table 32I and rule-based gallery rules table 32J are tables that process the rules based on data stored in the rule-based rules tables 32C-32H. Rule-based processing table 32I performs two functions. First, it provides database sharing system 1 with an efficiency by defining only the galleries for which rule-based matching must be performed. In other words, if a gallery doesn't use rule-based collection, the gallery will not be added to the queue for rule based processing. AlbumID is a field that defines the unique identifier of a gallery that uses rule-based collecting. If a given gallery's unique AlbumID appears in this table, then database sharing system 1 knows to periodically queue the rules for processing. The other fields, IncludeUnlisted, MaxImages, and MatchType dictate when a match to the rules populates the gallery with the rule-based collection rules. IncludeUnlisted tells database sharing system 1 whether to include unlisted files in the set of files used to populate the gallery. MaxImages tells database sharing system 1 whether there exists a ceiling for the number of images that will be collected into the gallery. MatchType tells database sharing system 1 whether to match all the rules defined for a gallery (conjunctive rule matching) or to match any of the rules defined for the gallery (disjunctive rule matching).

Rule-based gallery rules table 32J concatenates all of the rules for an album into a single table, together with fields that define the criteria against which a match is made. Each record is a rule. When an album is placed in the album queue to be updated, the rules for a given album are executed by finding the rules in this table. AlbumRecipeRuleId is a field that stores the unique identifier of particular rule table. AlbumID is a field that defines the unique identifier of the album from which the files are being collected. Type is a field that indicates which kind of rule the rule is. In this example, the Type field can be Keyword, Popular, Date, Geography, or Gallery. Operator indicates how whether to include matches to the rule or exclude matches to the rule. Finally Rule stores the actual rule options (e.g., for geography the latitude, longitude, and radius are stored; for keywords, the keywordID is stored).

### Example 5

### Queue Processing

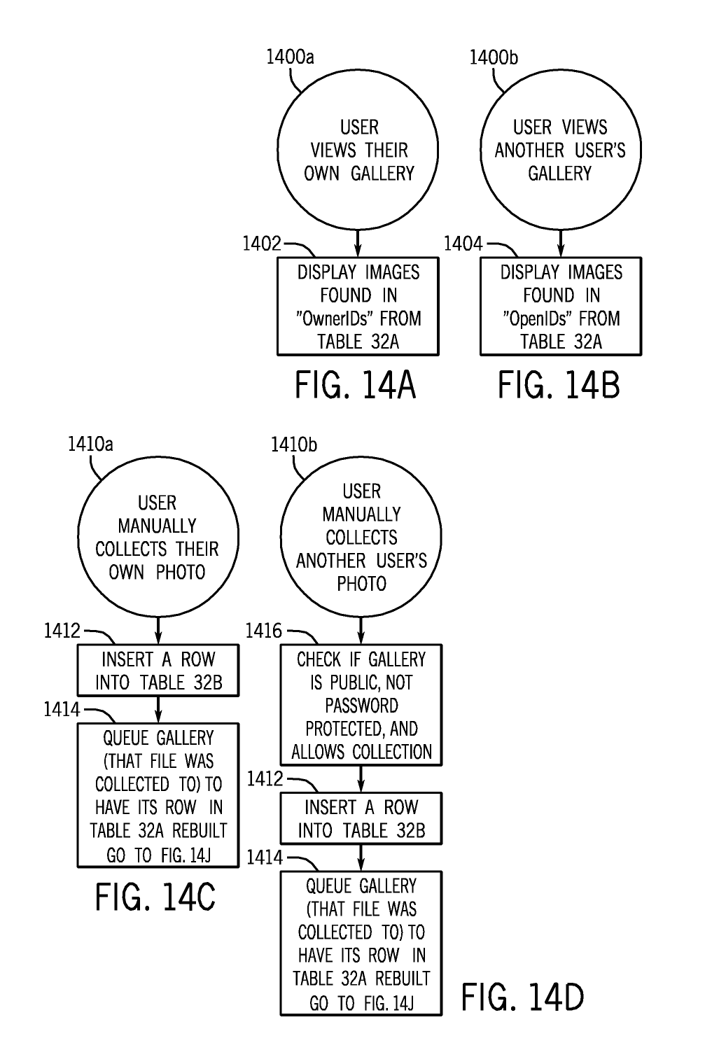

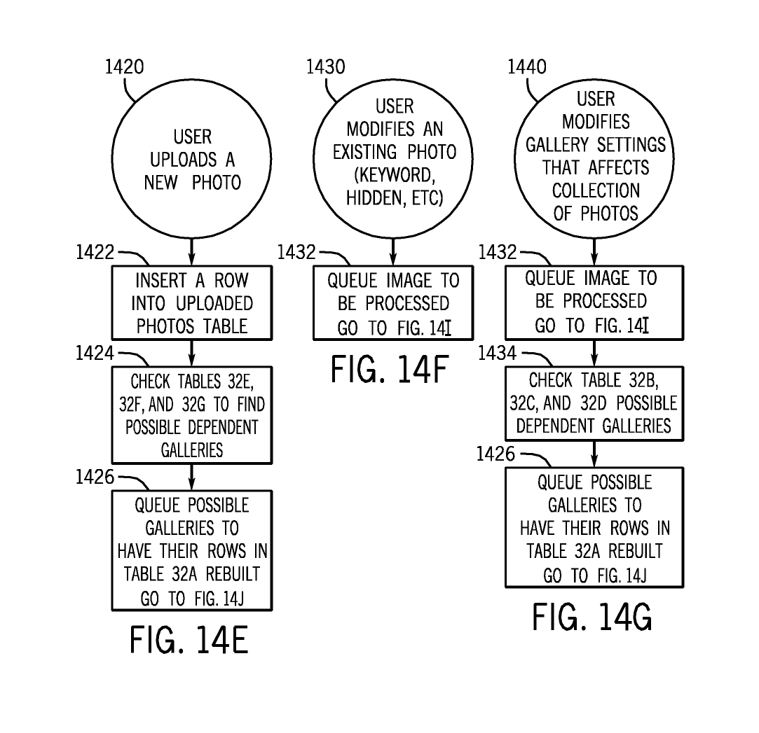

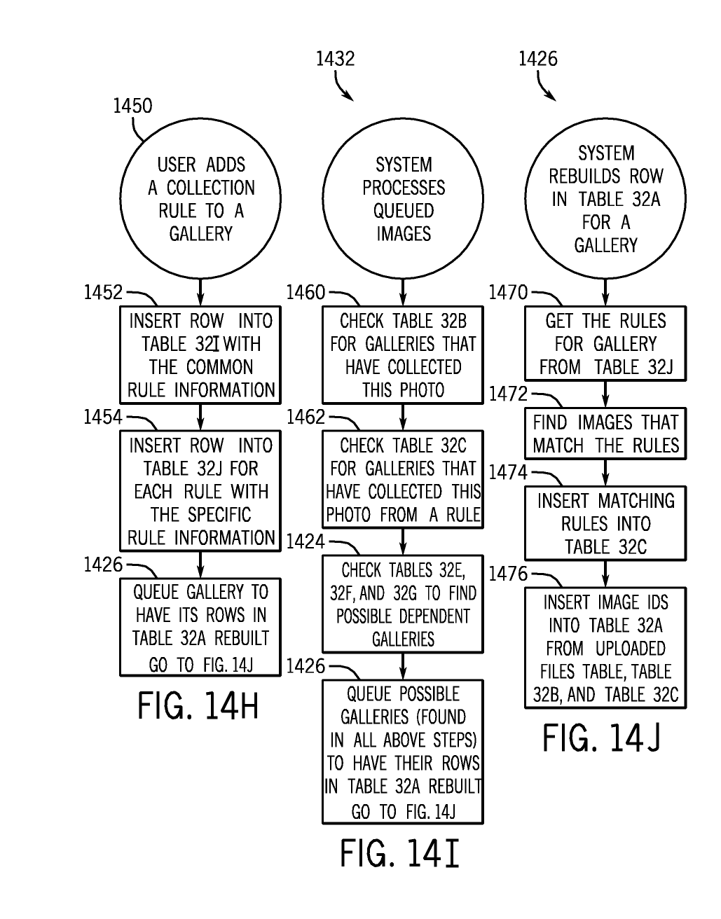

According to embodiments and as illustrated in FIGS. 14A-14J, a series of flow charts are shown where database sharing system 1 is an image sharing website.

FIGS. 14A and 14B illustrate how database sharing system 1 processes images for viewing. According to embodiments, if a user seeks to view her own gallery 500 in process 1400a, the unique image identifiers for one or more images are retrieved from the OwnerIDs field in gallery files table 32A and those files are displayed in gallery 500 in process 1402. If the user seeks to view her friend's images, as illustrated in FIG. 14B in process 1400b, the unique image identifiers for one or more images are retrieved from the OpenIDs field and those images are displayed in gallery 500 in process 1404.

FIGS. 14C and 14D illustrate flow when files are manually collected into a user's gallery, either from their own gallery 500 (FIG. 14C) or from another user's gallery 500 (FIG. 14D). When the user manually collects one of their own files into another one of their galleries 500 in process 1410a, a record (i.e., a database row) is added to manually collected files table 32B reflecting the collected file in process 1412. The same process is performed when a user seeks to manually collect another user's photos in process 1410b. However, prior to adding a record to manually collected files table 32B in process 1412, database sharing system 1 check to make sure the user has access to the other user's files and that the file that is to be collected is collectable in process 1416, and only continues to process 1412 if both the user can access the files and the files are collectable.

When a user uploads a new file, according to embodiments, in process 1420, a new record is created in an uploaded files table, which is similar to the manually collected files table 32B and rule-based collected files table 32C, except that it stores data related to files that have been uploaded by the user. According to embodiments, these three tables each feed file data into gallery files table 32A. When a new files is uploaded, the files must be checked to determine if it matches rules set forth in rule-based geography collected files table 32E, rule-based dates collected files table rules table 32F, or rule-based keyword collected files rules table 32G in process 1424. If the file produces a positive match for rules contained in these tables, then the galleries where the rules are defined are queued in the files queue to be rebuilt (i.e., have records updated reflecting the uploaded files that produces a match) in operation 1426, which is shown in greater detail in FIG. 14J.

When a user modifies and existing file by changing metadata such as keywords, making the file hidden, etc., as illustrated in FIG. 14F in process 1430, then the image is placed in the image queue in process 1432. Likewise, as illustrated in FIG. 14G, if modifications to the file have the possibility of affecting galleries that have collected the file (for example, if the file is marked from collectable to not collectable) in process 1440, then the file is also placed in the files queue for processing in process 1432. However, because the file could affect galleries that have collected it, process 1434 looks at manually collected files table 32B, rule-based collected files table 32C, rule-based gallery collected files rules table 32D, and queues in the files queue any gallery 500 that has collected the changed file in process 1426.

FIG. 14H illustrates embodiments where a user adds a rule-based collection rule to his gallery in process 1450. When the rule is added, database sharing system 1 adds a record in rule-based processing table 32I in process 1452 with the information related to the rule, as described in Example 4. In process 1454, database sharing system 1 inserts a record for each rule into rule-based album rules table 32J that defines the rule. Then the gallery is placed in the files queue to have gallery files table rebuilt (i.e., have the record for gallery 500 in gallery files table rebuilt from manually collected files table 32B, rule-based collected files table 32C, and uploaded files table) in process 1426.

FIG. 14I illustrates embodiments of file queue processing 1432, which processes the queued files. In process 1460, file queue checks manually collected files table 32B and determines galleries 500 that have collected the file that was queued in file queue. In process 1462, file queue checks rule-based collected files table for galleries that have collected the file that was queue in file queue. When a new files is uploaded, the files must be checked to determine if it matches rules set forth in rule-based geography collected files table 32E, rule-based dates collected files table rules table 32F, or rule-based keyword collected files rules table 32G in process 1424. The galleries located in processes 1460, 1462, and 1424 are then queued in gallery queue in process 1426.

FIG. 14J illustrates embodiments of gallery queue processing 1426, which processes galleries 500 that have been queued to be rebuilt. In process 1470, rules for a given gallery are retrieved from rule-based album rules table 32J and the rules are processed in process 1472 to find matches to the rules. In process 1474, files that are matching in process 1472 are insert as records into rule-based collected files table 32C. Process 1476 rebuilds the master gallery table (e.g., the record for the gallery in gallery files table 32A) by deleting the prior record and making a new record that combines the images for that gallery in manually collected files table 32B, rule-based collected files table 32C, and uploaded files table. After this process, gallery with collected or rule-based collected files will have reprocessed the rules for changes to files and new uploaded files, whereby gallery 500 will now be up to date.

According to embodiments, the devices, systems, or methods disclosed herein are operational in an information technology infrastructure or with numerous other general purpose or special purpose computing system environments or configurations. Examples of well known computing systems, environments, or configurations that may be suitable for use with the subject matter of this disclosure include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, or the like.

According to embodiments, the devices, systems, or methods disclosed herein are described in the general context of computer-executable instructions, such as program modules, being executed by a computer. Generally, program modules include, for example, routines, programs, objects, components, data structures, which perform particular tasks or implement particular abstract data types. The devices, systems, or methods disclosed herein may also be practiced in distributed computing environments where tasks are performed by remote processing devices that are linked through a communications network. In a distributed computing environment, program modules may be located in both local and remote computer storage media including memory storage devices. The computer programs are stored in a memory medium or storage medium or they may be provided to a processing unit through a network or I/O bus.

According to embodiments, the devices, systems, or methods disclosed herein include at least one central processing unit (CPU) or processor. According to embodiments, the CPU is coupled to a memory, ROM, or computer readable media containing the computer-executable instructions for implementing a database or the systems disclosed herein, as well as performing the methods disclosed herein. The machine readable media may store instructions or data which implement all or part of the system or methods described herein. According to embodiments, machine readable media is any available media that can be accessed by the devices or systems disclosed herein, or by computers generally, and includes both volatile and nonvolatile media, removable and non-removable media implemented in any method or technology for storage of information such as computer readable instructions, data structures, program modules, or other data. Computer storage media includes, but is not limited to: random access memory; read-only memory; EEPROM; flash memory; portable memory or other memory technology; CD-ROM, digital versatile disks (DVD), or other optical disk storage; magnetic cassettes, magnetic tape, magnetic disk storage, or other magnetic storage devices; or any other medium which can be used to store the desired information and which can be accessed by the data capture system disclosed herein.

Communication media typically embodies computer readable instructions, data structures, program modules, or other data in a modulated data signal such as a carrier wave or other transport mechanism and includes any information delivery media. By way of example, and not limitation, communication media includes wired media such as a wired network or direct-wired connection, and wireless media such as acoustic, radio frequency, infrared, or other wireless media. Combinations of any of the above should also be included within the scope of communications media.

While the apparatus and method have been described in terms of what are presently considered to be practical and effective embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

While the apparatus and method have been described in terms of what are presently considered to be the practical and effective embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system comprising:
a server;
a database having information that can be used to locate a plurality of files,
each file having a record in the database and being associated with a gallery;
a back-end; and
a front-end;
wherein the owner of each gallery can collect files from another gallery if and only if:
the files in the other gallery are public; and
the files in the other gallery are marked collectable;
wherein the a user can either manually collect the files or have the files automatically collected based on at least one rule defined by the user.

2. The system of claim 1, wherein the at least one rule is based on at least one of the following: keyword, date, geography, and being in another gallery.

3. The system of claim 1, wherein the user is the owner.

4. The system of claim 3, wherein the user can collect the file irrespective of whether the file has been designated as public or the file has been designated as collectable.

5. The system of claim 1, wherein the files are photograph files.

6. A method comprising, on a computer:
receiving a file from a file owner into a first gallery owned by the file owner, wherein when the file is received, a record of the file is made in a first gallery table associated with the first gallery;
causing storage of the file in a file storage;
providing a set of settings options to the file owner comprising at least an option to make the file public and allow the file to be collected; and
receiving a request from a user to collect the file into a gallery owned by the user, wherein a record of the file is made in a second gallery table, thereby causing the file to be collected into the second gallery;
wherein the file is collected to the second gallery only if the owner has designated the file as public and designed that the file is collectable;
wherein only a single copy of the file is contained in the file storage.

7. The method of claim 6, wherein the user is the owner.

8. The method of claim 7, wherein the user can collect the file irrespective of whether the file has been designated as public or the file has been designated as collectable.

9. The method of claim 6, wherein the files are photograph files.

10. A machine readable medium having instructions thereon comprising:
receiving a file from a file owner into a first gallery owned by the file owner, wherein when the file is received, a record of the file is made in a first gallery table associated with the first gallery;
causing storage of the file in a file storage;
providing a set of settings options to the file owner comprising at least an options to make the file public and allow the file to be collected; and
receiving a request from a user to collect the file into a gallery owned by the user, wherein a record of the file is made in a second gallery table, thereby causing the file to be collected into the second gallery;
wherein the file is collected to the second gallery only if the owner has designated the file as public and designed that the file is collectable;
wherein only a single copy of the file is contained in the file storage.

11. The machine readable medium of claim 10, wherein the user is the owner.

12. The machine readable medium of claim 11, wherein the user can collect the file irrespective of whether the file has been designated as public or the file has been designated as collectable.

13. The machine readable medium of claim 10, wherein the files are photograph files.
